(19) United States
(12) Patent Application Publication
(10) Pub. No.: US 2018/0373997 A1
(43) Pub. Date: Dec. 27, 2018

(54) AUTOMATICALLY STATE ADJUSTMENT IN REINFORCEMENT LEARNING

(71) Applicant: International Business Machines Corporation, Armonk, NY (US)

(72) Inventors: Ning DUAN, Beijing (CN); Jing Chang HUANG, SHANGHAI (CN); Peng JI, Nanjing (CN); Chun Yang MA, Beijing (CN); Jie MA, Nanjing (CN); Zhi Hu WANG, Beijing (CN)

(21) Appl. No.: 15/628,983

(22) Filed: Jun. 21, 2017

(51) Int. Cl. G06N 99/00; G06N 5/02

(52) U.S. Cl. CPC G06N 99/005; G06N 5/025

(57) ABSTRACT

A system, a computer program product, and method for automatic state adjustment in reinforcement learning is described. The method begins with operating a reinforcement learning model using a state-action table with a set of environment states, a set of software agent states of at least one software agent, a set of actions corresponding to the set of environmental states and software agent states, a plurality of policies of transitioning from the environmental states and software agent states to actions, rules that determine a scalar immediate reward based on the transitioning, and rules that describe what the at least one software agent observes. An unstable state is identified from a series of values of the set of actions in the state-action table in which the series of values differ from each other by a settable threshold. Policies or factors are selected to split the unstable state that has been identified.

### BACKGROUND

The present invention generally relates to machine learning and more specifically relates to state adjustment in reinforcement learning.

Development of the Internet of Things (IoT) has grown rapidly over the last few years. IoT is the network of physical objects—devices, vehicles, buildings and other items—embedded with electronics, software, sensors, and network connectivity that enables these objects to collect and exchange data.

One application of IoT is IoT for automotive. Connected vehicles are now able to analyze real-time information to provide new insights to vehicle users and fleet operators, optimizing their experience. Information is derived from vehicles and in-vehicle data in order to understand the drivers, helping keep them safe. Engineers are connected to vehicle data throughout its life to improve and enhance its capabilities and avoid quality issues and recalls.

### SUMMARY

One embodiment of the present invention is a computer-implemented method for automatic state adjustment in reinforcement learning. The method begins with operating a reinforcement learning model using a state-action table with a set of environment states, a set of software agent states of at least one software agent, a set of actions corresponding to the set of environmental states and software agent states, a plurality of policies or factors of transitioning from the environmental and software agent states to actions, rules that determine a scalar immediate reward based on the transitioning, and rules that describe what the at least set of software agent observes. For exampling the state-action table may store a set of environment states that represent data captured with environmental sensors.

At least one unstable state is identified from a series of values of the set of actions in the state-action table in which the series of values differ from each other by a settable threshold. One or more policies is selected to split the at least one unstable state that has been identified. The policies selected are used to split the unstable state to a multiple set of new states in the state-action table.

In one embodiment, the one or more policies is selected includes selecting with one or more of a regression model, a Pearson correlation coefficient, or mutual information between rows of the state-action table.

In another embodiment, the one or more policies is selected includes selecting polices with a high correlation between a numerical value of the policies and a score adjustment trend.

In another embodiment, the one or more policies is selected includes selecting polices includes selecting policies with a low correlation between the categorical value and a value for stableness.

Stable states are merged by identifying at least one stable state from a series of values of the set of actions in the state-action table in which the series of values differ from each other by a settable threshold and based on the at least one stable state selected, merging the at least one stable state to a single set of states in the state-action table.

Other embodiments of the invention include a system and a computer program product.

### BRIEF DESCRIPTION OF THE DRAWINGS

In the accompanying figures, like reference numerals refer to identical or functionally similar elements throughout the separate views. The accompanying figures, together with the detailed description below are incorporated in and form part of the specification and serve to further illustrate various embodiments and to explain various principles and advantages all in accordance with the present invention, in which:

FIG. 1 is a block diagram of Internet of Things (IoT) for automotive, according to an embodiment of the present invention;

FIG. 2 is a state-action table, according to an embodiment of the present invention;

FIG. 3 illustrates an update to a state-action table based on user-feedback, according to an embodiment of the present invention;

FIG. 4 illustrates identifying unstable state and splitting the state into more than one states and then merging stable states in the state-action table, according to an embodiment of the present invention;

FIG. 5 is a block diagram of the major components of an automatic state adjustment system for reinforcement learning, according to an embodiment of the present invention;

FIG. 6 is a state-action table of convergence evaluator of FIG. 5, according to an embodiment of the present invention; and

FIG. 7 illustrates a factor selector to be used when splitting an unstable state into more than one row in the state-action table, according to an embodiment of the invention;

FIG. 8 illustrates a factor selector to be used when splitting an unstable state into more than one row in the state-action table using a single factor, according to an embodiment of the invention;

FIG. 9 illustrates a factor selector to be used when splitting an unstable state into more than one row in the state-action table using multiple factors, according to an embodiment of the invention;

FIG. 10 illustrates a state merger when combining more than one row into a single row in the state-action table, according to an embodiment of the invention;

FIG. 11 illustrates one example of a cloud computing node, in accordance with an embodiment of the present invention;

FIG. 12 illustrates one example of a cloud computing environment, in accordance with an embodiment of the present invention; and

FIG. 13 illustrates an abstraction model layers, in accordance with an embodiment of the present invention.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention is presented for purposes of illustration and description, but is not intended to be exhaustive or limited to the invention in the form(s) disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. The terminology used herein is for the purpose of describing particular embodiments only and is not intended to be limiting of the invention.

Although the following examples and applications are used with IoT applied to the automotive industry, the application of the present invention is not limited to IoT for automotive field or even IoT itself.

Today's cars are more connected than ever before. Connectivity enables new business models. To gain a competitive edge, automakers, suppliers and service providers need to look at cognitive IoT as a transformative opportunity. These opportunities include: i) linking drivers and cars to the surrounding environment to improve the mobility experience; ii) continuous engineering for automotive and intelligent assets and equipment; and iii) analyze in-context IoT information to bring more certainty to your business decision making.

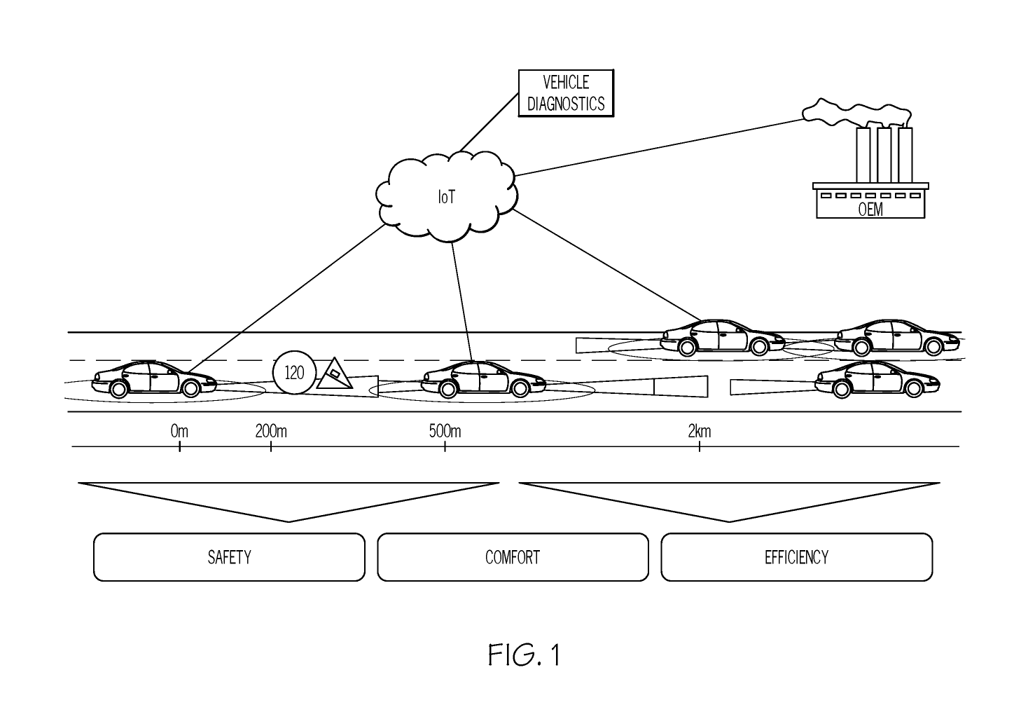

FIG. 1 is a block diagram 100 of Internet of Things (IoT) for automotive, according to an embodiment of the present invention. The Internet of Things (IoT) continues to grow in many fields. The fields are automotive link drivers and cars to improve driving experience. Electronics manage millions of IoT devices easily and securely to gain insights improve customer experience and enable new business models. Insurance to provide protection to increase customer satisfaction, lower costs, and mitigate risks. Manufacturing to improve quality, increase efficiency, and optimize performance. And retail optimize store operations and manage customer experiences.

The present invention provides a method and apparatus for automatic state adjustment in reinforcement learning using a state-action table. A reinforcement learning model using a state-action table with a set of environment states, a set of software agent states of at least one software agent, a set of actions corresponding to the set of environmental states and software agent states, a plurality of policies of transitioning from the environmental states and software agent states to actions, rules that determine a scalar immediate reward based on the transitioning, and rules that describe what the at least one software agent observes. An unstable state is identified from a series of values of the set of actions in the state-action table in which the series of values differ from each other by a settable threshold. One or more policies or factors are selected to split the unstable state that has been identified. Splitting the unstable state, using the policies selected, to a multiple set of new states in the state-action table. Later, the stable states are merged.

The present invention overcomes the difficulty in setting thresholds for state adjustment in reinforcement learning systems. The present invention addresses the challenges of having sufficient data before constructing the state-action table in which proper thresholds are continuously varying. The present invention eliminates the challenge of simply dividing the value domain into sufficient categories to guarantee correct state identification. The more partition means more rows in the table. (2ⁿ vs. Mⁿ). This means more scores needs to be filled or trained. This also means more data needed to achieve convergence. The present invention overcomes this growth in required data.

### Non-Limiting Definitions

The terms “a”, “an” and “the” are intended to include the plural forms as well, unless the context clearly indicates otherwise.

The terms “comprises” and/or “comprising,” when used in this specification, specify the presence of stated features, steps, operations, elements, and/or components, but do not preclude the presence or addition of one or more other features, integers, steps, operations, elements, components, and/or groups thereof.

The “reinforcement learning model” includes a set of environment and software agent states, a set of actions of the software agent, policies of transitioning from the environmental and software agent states to actions, rules that determine the scalar immediate reward based on the transitioning and rules that describe what the software agent observes.

The term “software agent” or just “agent” or “reinforcement learning agent” when used in this specification with the reinforcement learning model means software that take actions in an environment so as to maximize a cumulative reward. For example, consider teaching a pet, which in this example is the reinforcement learning agent, a new trick: you cannot tell it what to do, but you can reward/punish it if it does the right/wrong thing. It has to figure out what it did that made it get the reward/punishment, which is known as the credit assignment problem. A similar method can be used to train computers to do many tasks, such as playing backgammon or chess, scheduling jobs, and controlling robot limbs. The typical framing of a reinforcement learning scenario: an agent takes actions in an environment which is interpreted into a reward and a representation of the state which is fed back into the agent. <See generally wikipedia.org/wiki/Reinforcement_learning>. The “reinforcement learning agent” is a finite state machine with inputs (observations/rewards sent from the environment) and outputs (actions sent to the environment).

The term “software agent state” or just “state” when used in this specification with the reinforcement learning model means a numeric value within a finite state machine with inputs which are actions sent from the software agent, and outputs which are observations and rewards sent to the software agent.

### State Action Table

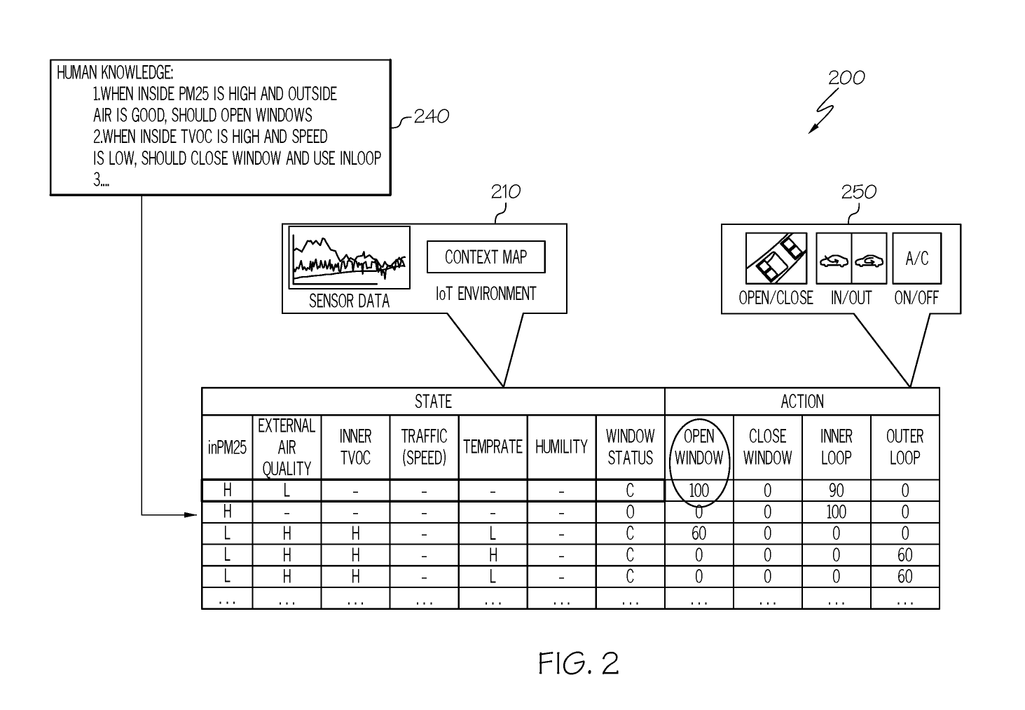

FIG. 2 is a state-action table 200, according to an embodiment of the present invention. More specifically, shown are rows of states 210 (e.g., environmental states) and the corresponding actions 250 based on human knowledge 240. This example tracks human state-actions 230. In this example “H” means relatively high and “L” means relatively low based on a settable threshold by the user. Each state is typically from sensor data where the prefix “in” means interior to the automobile and the prefix “out” means outside the automobile and “diff” means the difference between inside and outside. These factors include interior PM25, which is the concentration of particular matters (air pollutants) with a diameter of 2.5 micrometers or less. It is a measure of air pollution. PM25Diff is the difference in measurement of particular matters in the inside and outside. Other factors include each of TVOC (total volatile organic compounds), speed of automobile, inside temperature, temperature difference, outside temperature, inside humidity, outside humidity, window status (open/close) and the actions are windows being open/closed, recirculate (inner versus outer loop) and air condition on or off. The numbers “80”, “0”, “90” and “0” are rewards or a score of a particular action. Typically an action with the highest reward is selected.

In FIG. 2, a cognitive model: state-action table is show in which a state is determined by a set of factors. Every factor of a state is determined as a categorical value (“H”/“M”/“L”, “O”/“C”). If the factor doesn't matter in some state, it could be undetermined as null. Each action has a score. The action with maximum score will be taken.

### State Action Table at Time T1 and Later Time T2

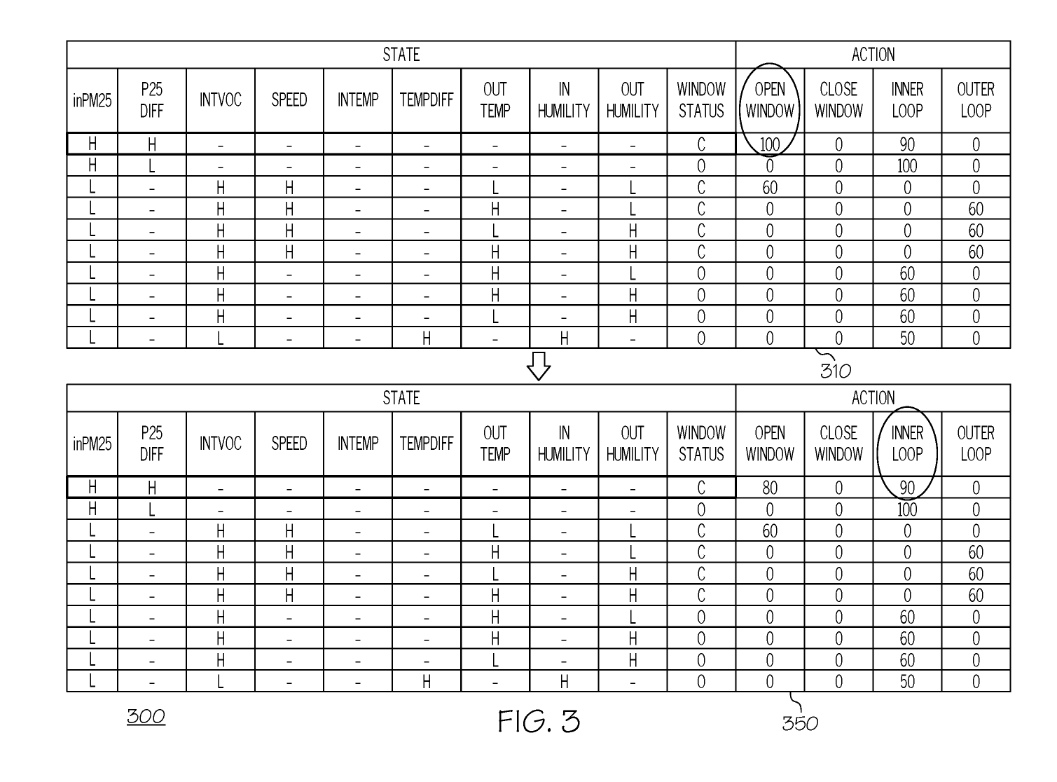

FIG. 3 illustrates an update to a state-action table 300 based on user-feedback, according to an embodiment of the present invention. The states and actions change from a time T1 on the left to a time T2 on the right. More specifically, shown are rows of states 310 and the corresponding actions 350. Action scores in the table on the right for T2 are adjusted based on user feedback and/or sensor readings.

For example: After taken on action, adjust the score based on user feedback and sensor readings the Air quality function Func(inPM25, inTVOC, inHumidity, . . . ) provides:

If the value of Func( ) increases, the action has positive effect, then increase its score.

If the value of Func( ) doesn't change or decreases, decrease its score.

After decreasing the score of “open window” by 20, “inner loop” becomes the chosen action of this state.

### Identifying Unstable and Splitting Unstable States, Identifying Stable Merging Stable States

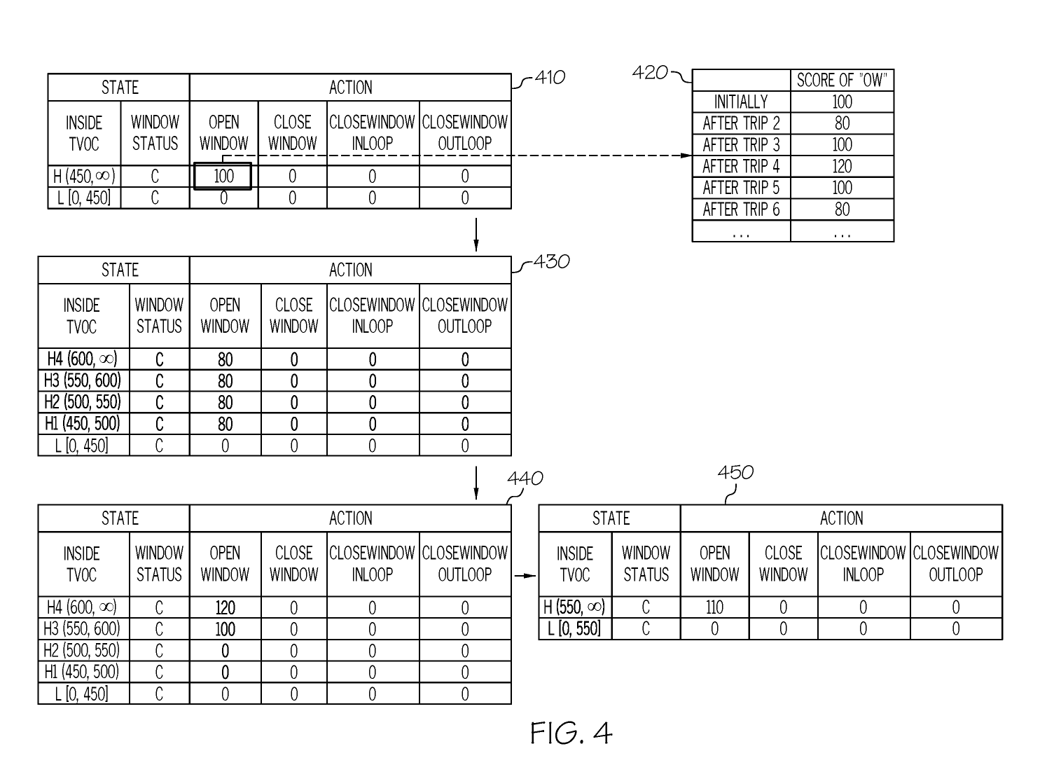

FIG. 4 illustrates identifying unstable state and splitting the state into more than one state. The score of open window is varying after each trip, i.e. trip 2, trip 3, trip 4, trip 5, and trip 6, as shown in table 420. An unstable state is identified by detecting this variation or vibration in the score. Once this variation is detected, the row for the unstable state is spit into “N” or more rows as shown in table 430. In this example, the single row of table 410 that was unstable is divided into four rows in table 430 as shown. In this example, infinity is 650 and the domain is uniformly divided into four (4) regions. It is important to note that other methods for dividing up a range of numbers may be used including using exponent and logarithmic scales

Likewise, when a state is identified as being stable in 440, then two or more of the rows in the state-action table are combined into one row as shown in 450. The values in each row being combined can be averaged. In another example the values can be combined using a formula rather than just straight averaging.

### State Adjustment

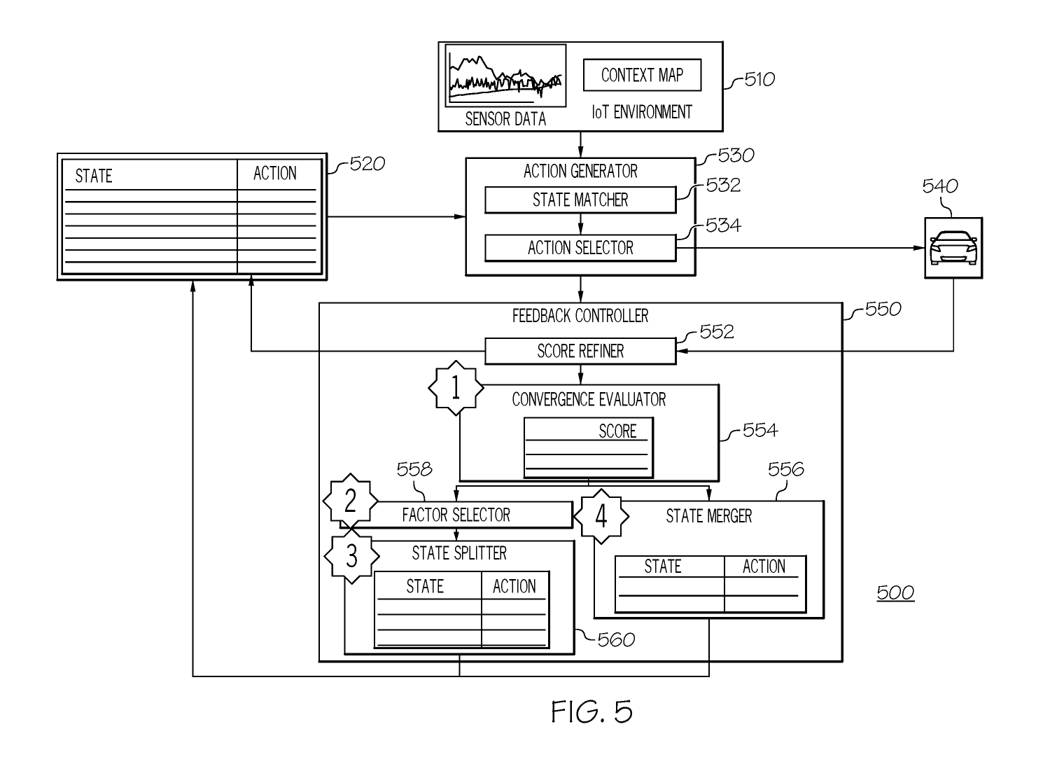

FIG. 5 is a block diagram 500 of the major components of an automatic state adjustment system for reinforcement learning, according to an embodiment of the present invention. Sensor data 510 and state-action table 520 is made available to action generator 530. There is a state matcher 532 which groups states according to their similarity. A state match is used to determine which state the software agent is currently in, based on the given sensor data. In reinforcement learning, the software agent is analogous to a human brain to determine which action to take. The software again may choose any action as a function of the history or can randomize is action selection.

Also in the action generator 530 is an action selector 534. Once the current state which the software agent is in is determined, the Action Selection selects which action to take. Normally, the action with highest reward will be selected. An Action Selection notification is sent to automotive 540 and feedback received by score refiner 552.

A feedback controller 550 includes a score refiner 552. The score refiner or reward refiner is used to review the score or reward of action based on the feedback (results) after the action is taken. Also includes in the feedback controller 550 is a convergence evaluation 554 which identifies unstable or stable states from a series of value of the set action in the state action table 520.

In the case that an unstable state has been identified, the convergence evaluator feeds into a factor selector 568 and state splitter 560 for state-action table 520. One or more policies or factors are used to split the unstable state that has been identified. Examples of policies include regression model, a Pearson correlation coefficient, or mutual information between rows of the state-action table.

In one embodiment, the selection of the unstable state to split is based upon the one or more polices or factors with a high correlation between a numerical value of the policies or factors and a score adjustment trend.

In another embodiment, the selection of the unstable state to split is based upon at least one categorical value for the policies or factors with a low correlation between the categorical value and a value for stableness.

On the other hand if a stable state is identified, the state merger is processed in step 560 for identified stable state in the state action table 520.

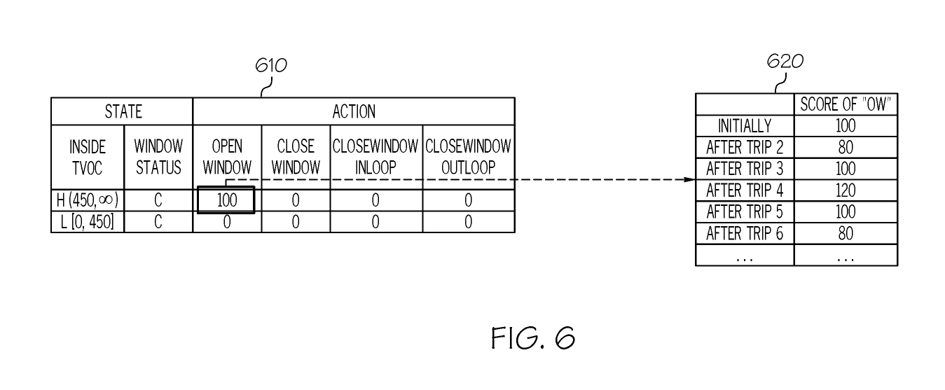

FIG. 6 is a state-action table of convergence evaluator 554 of FIG. 5, according to an embodiment of the present invention. Shown is an evaluation of whether the new updated score in the state-action table 610 based on feedback from the vehicle/sensors is stable 620. The output is one of stable meaning the same value from a series of values of the set of actions in the state-action table 520 in which the series of values are within a certain range from each other by a settable threshold or differ from each other by a settable threshold which mean “vibrating” or unstable. Another output possible is a middle status that is not stable or not unstable according to the thresholds.

### Factor Selector

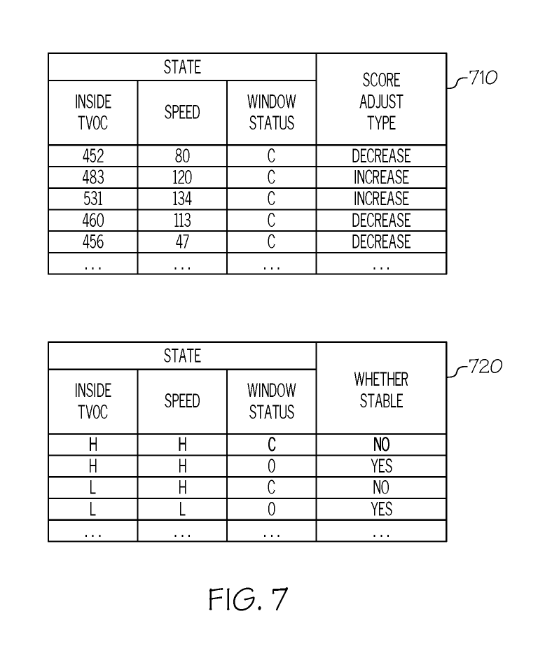

FIG. 7 illustrates a factor selector to be used when splitting an unstable state into more than one row in the state-action table, according to an embodiment of the invention. Shown are two options. The first option is option is to consider the numerical value of factors and select factors with high correlation with the score adjust type (“increase” or “decrease”) to split 710. A correlation is determined based on regression model, Pearson correlation coefficient, mutual Information. As an example, sort the correlation coefficient, TVOC>Speed>Window Status, Therefore, split “TVOC” first, “speed” if instability or vibration is too obvious.

The second option for factor selector is compare the new detected unstable state with other state: consider the categorical values of factors and select factors with low correlation with the state stableness to split 720.

### Single Factor Splitter

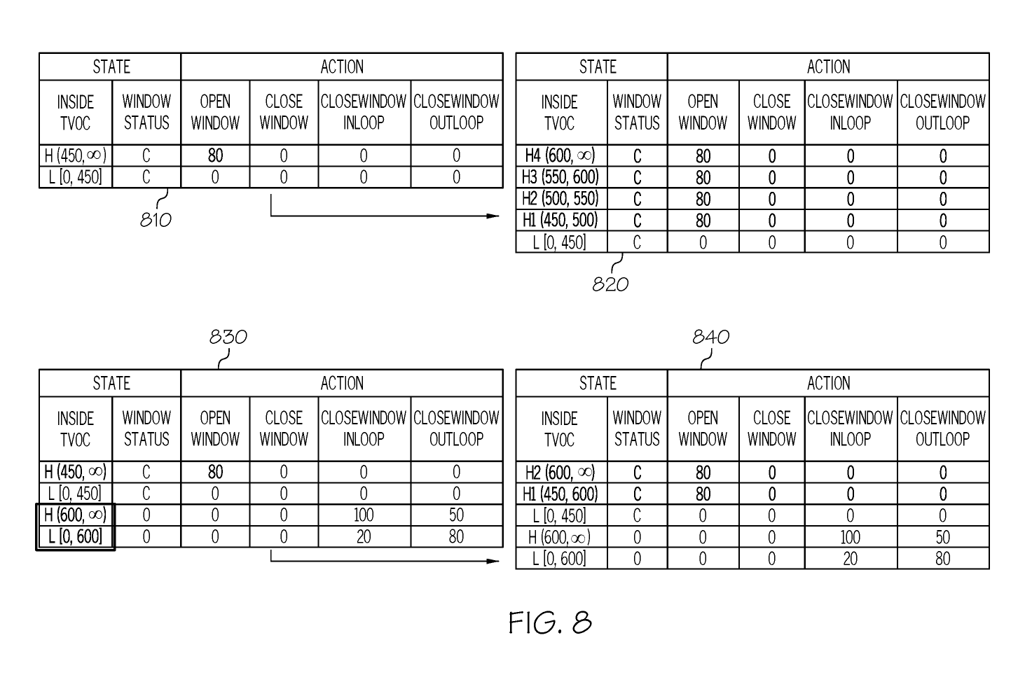

FIG. 8 illustrates a factor selector to be used when splitting an unstable state into more than one row in the state-action table using a single factor, according to an embodiment of the invention. Input: domain of the factor of the unstable state. For example, Inside TVOC: H(450, ∞). When no preliminary knowledge is known, uniformly partition the factor domain into N partitions 810 and 820. And values of all other state factors and action scores are the same as existing. In another embodiment or a more advanced approach is to utilize preliminary knowledge indicated by stable states. Split at the threshold value of the same factor in stable states 830 and 840.

### Multiple Factor Splitter

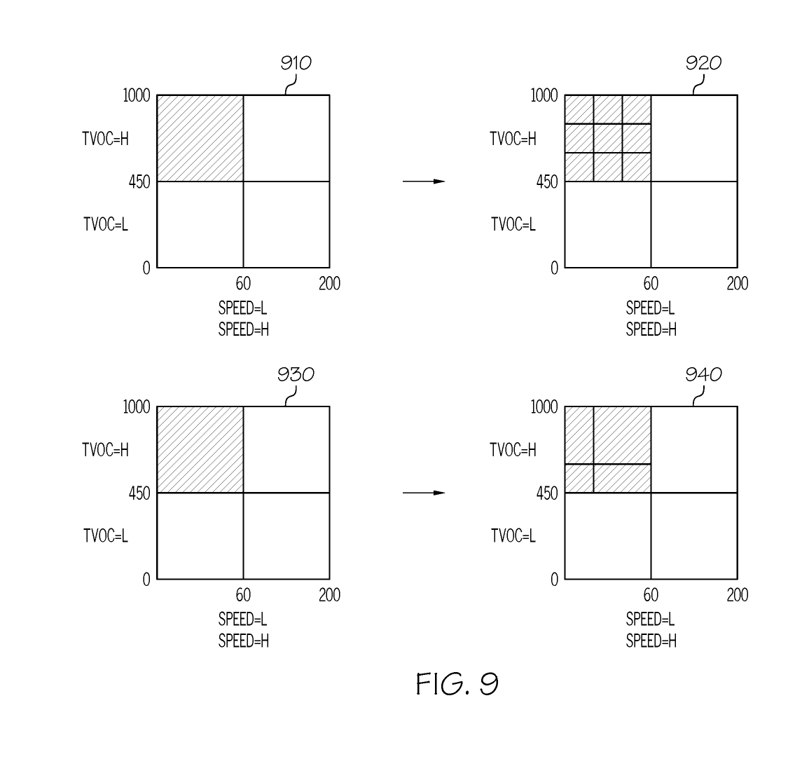

FIG. 9 illustrates a factor selector to be used when splitting an unstable state into more than one row in the state-action table using multiple factors, according to an embodiment of the invention. Input: domain of factors of the unstable state 910. For example, Inside TVOC: H(450, ∞), speed: (0, 60]. When no preliminary knowledge is known, uniformly partition the factor domain into N partitions 920. In this example N=3. Values of all other state factors and action scores are the same as existing.

In another embodiment or advanced approach: utilizing preliminary knowledge indicated by stable states 930. Split at the threshold value of the same factor in stable states 940.

### State Merger

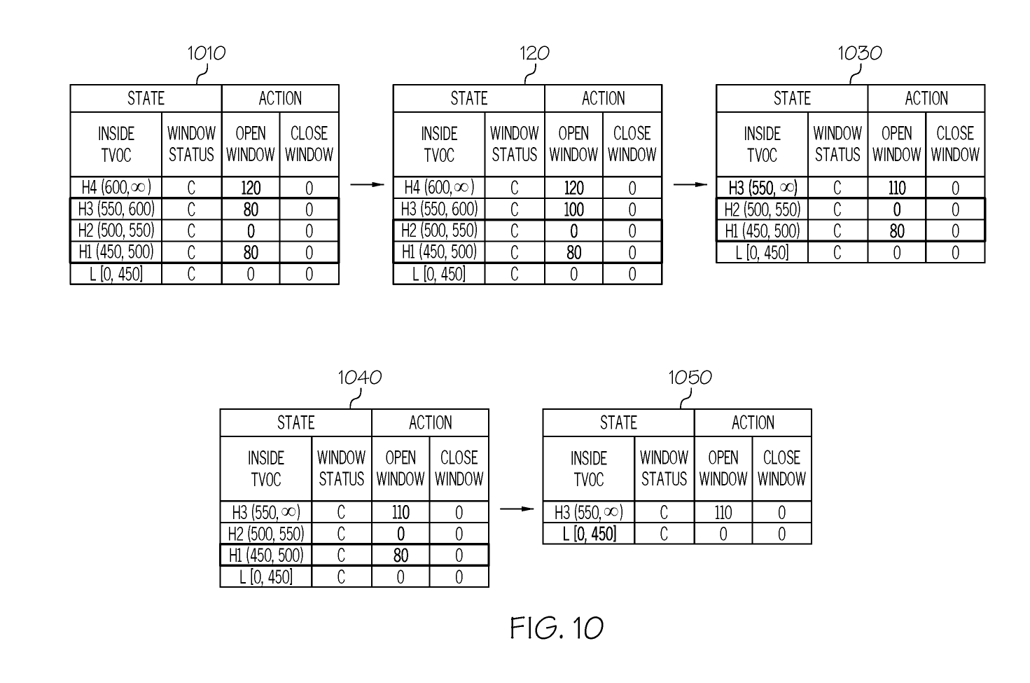

FIG. 10 illustrates a state merger when combining more than one row into a single row in the state-action table, according to an embodiment of the invention. For each state becoming stable, merge it with other stable state 1010 (H4 achieves stable, no state to merge), 1020 (H3 achieves stable, merge with H4), and 1030. Requirement: Merged states are “adjacent” in domain space. − domains are successive. Active actions are the same. Differences of active actions are within a threshold.

In another embodiment or advance approach for those states barely being visited, merge them with nearby stable state based on linear continuity. H1 not being visited for a long enough time. Merge H2, H1, L as shown in 1040 and 1050.

### Generalized Computing Environment

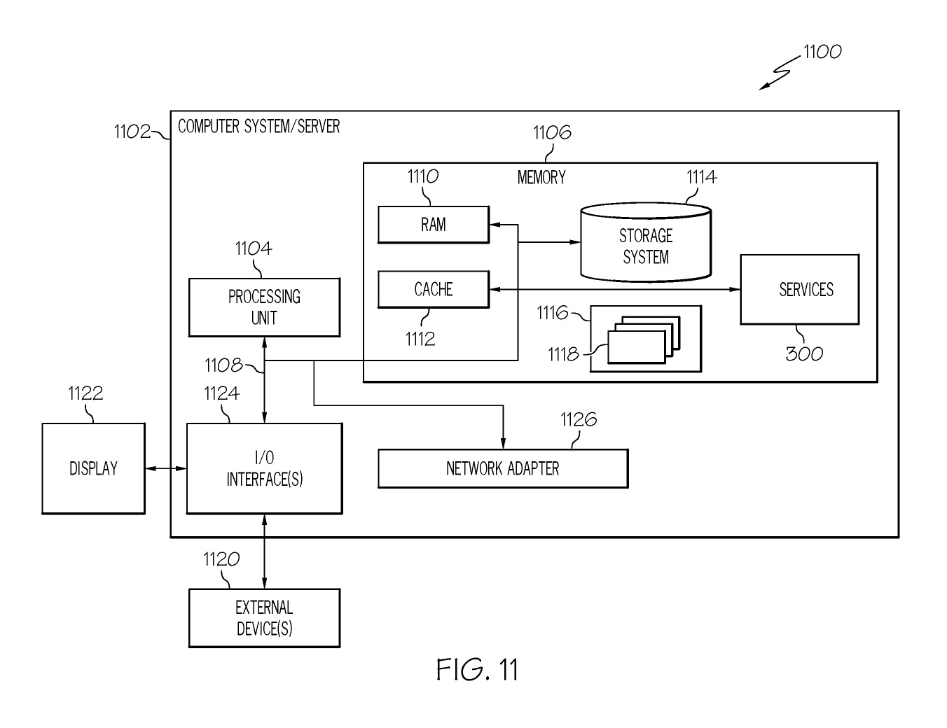

FIG. 11 illustrates one example of a processing node 1100, in accordance with an embodiment the present invention. This example is not intended to suggest any limitation as to the scope of use or functionality of embodiments of the invention described herein and the processing node 1100 is capable of being implemented and/or performing any one or more of the functionalities set forth herein.

As depicted, processing node 1100 can be a computer system/server 1102, which is operational with numerous other general purpose or special purpose computing system environments or configurations. Examples of well-known computing systems, environments, and/or configurations that may be suitable for use with computer system/server 1102 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1102 may be described in the general context of computer system-executable instructions, such as program modules as further described below, being executed by a computer system. Generally, program modules may include routines, programs, objects, components, logic, data structures, and so on that perform particular tasks or implement particular abstract data types. Computer system/server 1102 may be practiced as one node of a distributed cloud computing environment, an example of which will be described with reference to FIG. 11. In such cloud computing environments, tasks are performed by remote processing devices that are linked through a communications network. In a distributed cloud computing environment, program modules 1118 may be stored in one or more local and remote computer system storage media, including memory storage devices.

As shown in FIG. 11, computer system/server 1102 in cloud computing node 1100 is shown in the form of a general-purpose computing device. The components of computer system/server 1102 may include, but are not limited to, one or more processors or processing units 1104, a system memory 1106, and a bus 1108 that couples various system components including system memory 1106 to processor 1104.

Bus 1108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1102 typically includes a variety of computer system readable media. Such media may be any available media that is accessible by computer system/server 1102, and it includes both volatile and non-volatile media, removable and non-removable media.

System memory 1106, in one embodiment, implements the functions of FIG. 5 through FIG. 10 and the processes described with reference to FIG. 5. The system memory 1106 can include computer readable media in the form of volatile memory, such as random access memory (RAM) 1110 and/or cache memory 1112. Computer system/server 1102 may further include other removable/non-removable, volatile/non-volatile computer system storage media. By way of example only, storage system 1114 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1108 by one or more data media interfaces. As will be further depicted and described below, memory 1106 may include at least one computer program product having a set (e.g., at least one) of program modules 1118 stored that are configured to carry out functions of various embodiments of the invention.

Program/utility 1116, having a set (at least one) of program modules 1118, may be stored in memory 1106 by way of example, and not limitation, as well as an operating system, one or more application programs, other program modules, and program data, such as services 300 described above with reference to FIGS. 1 and 2. Each of the operating system, one or more application programs, other program modules, and program data or some combination thereof, may be adapted to a networking environment. In some embodiments, program modules 1118 carry out the functions and/or methodologies of various embodiments of the invention described herein.

With reference again to FIG. 11, computer system/server 1102 may also communicate with one or more external devices 1120 such as a keyboard, a pointing device, a display 1122, etc. Such external devices 1120 include one or more devices that enable a user to interact with computer system/server 1102; and/or any devices (e.g., network card, modem, etc.) that enable computer system/server 1102 to communicate with one or more other computing devices. Such communication/interaction can occur via I/O interfaces 1124. In some embodiments, computer system/server 1102 can communicate with one or more networks such as a local area network (LAN), a general wide area network (WAN), and/or a public network (e.g., the Internet) via network adapter 1126. As depicted, network adapter 1126 communicates with the other components of computer system/server 1102 via bus 1108. It should be understood that although not shown, other hardware and/or software components could be used in conjunction with computer system/server 1102. Examples, include, but are not limited to: microcode, device drivers, redundant processing units, external disk drive arrays, RAID systems, tape drives, and data archival storage systems, etc.

### Computer Program Product Support

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Cloud Computing Environment

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

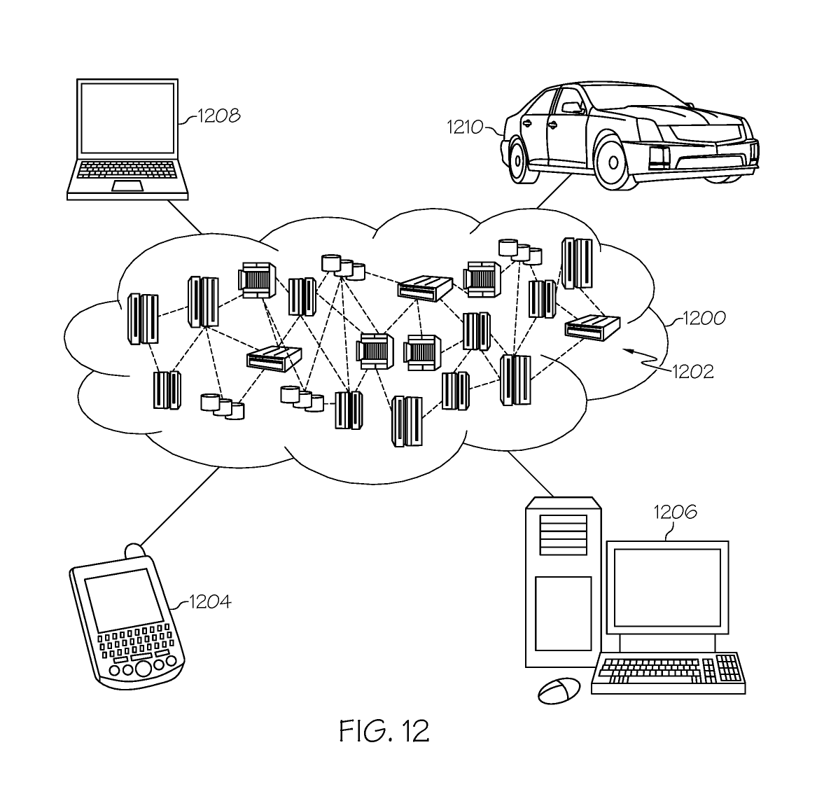

Referring now to FIG. 12, illustrative cloud computing environment 1200 is depicted. As shown, cloud computing environment 1200 comprises one or more cloud computing nodes 1202 with which local computing devices used by cloud consumers, such as, for example, personal digital assistant (PDA) or cellular telephone 1204, desktop computer 1206, laptop computer 1208, and/or automobile computer system 1210 may communicate. Nodes 1202 may communicate with one another. They may be grouped (not shown) physically or virtually, in one or more networks, such as Private, Community, Public, or Hybrid clouds as described hereinabove, or a combination thereof. This allows cloud computing environment 1200 to offer infrastructure, platforms and/or software as services for which a cloud consumer does not need to maintain resources on a local computing device. It is understood that the types of computing devices 1204, 1206, 1208, 1210 shown in FIG. 12 are intended to be illustrative only and that computing nodes 1202 and cloud computing environment 1200 can communicate with any type of computerized device over any type of network and/or network addressable connection (e.g., using a web browser).

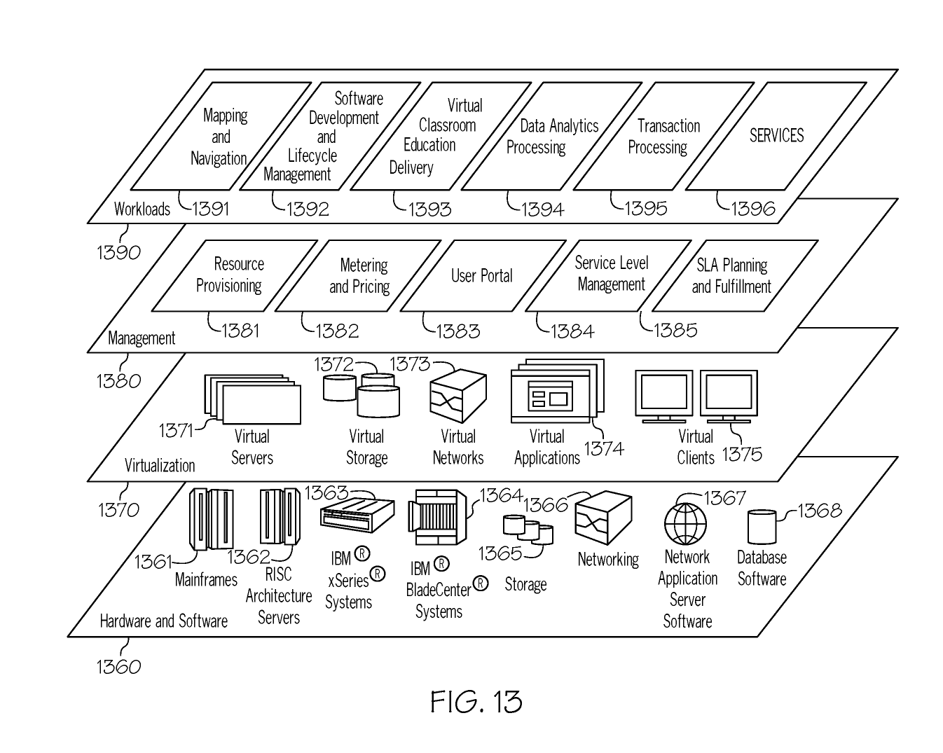

Referring now to FIG. 13, an exemplary set of functional abstraction layers provided by cloud computing environment 1200 is shown. It is understood in that the components, layers, and functions shown in FIG. 13 are illustrative only and embodiments of the invention are not limited thereto. As depicted, the following layers and corresponding functions are provided:

Hardware and software layer 1360 includes hardware and software components. Examples of hardware components include: mainframes 1361; RISC (Reduced Instruction Set Computer) architecture based servers 1362; servers 1363; blade servers 1364; storage devices 1365; and networks and networking components 1366. In some embodiments, software components include network application server software 1367 and database software 1368.

Virtualization layer 1370 provides an abstraction layer from which the following examples of virtual entities may be provided: virtual servers 1371; virtual storage 1372; virtual networks 1373, including virtual private networks; virtual applications and operating systems 1374; and virtual clients 1375.

In one example, management layer 1380 may provide the functions described below. Resource provisioning 1381 provides dynamic procurement of computing resources and other resources that are utilized to perform tasks within the cloud computing environment. Metering and Pricing 1382 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1383 provides access to the cloud computing environment for consumers and system administrators. Service level management 1384 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 1390 provides examples of functionality for which the cloud computing environment may be utilized. Examples of workloads and functions which may be provided from this layer include: mapping and navigation 1391; software development and lifecycle management 1392; virtual classroom education delivery 1393; data analytics processing 1394; transaction processing 1395; and 1396 for delivering services to develop software collaboratively in accordance with embodiments of the present invention.

### Non-Limiting Examples

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for automatic state adjustment, the method comprising:
operating a reinforcement learning model using a state-action table with a set of environment states, a set of software agent states of at least one software agent, a set of actions corresponding to the set of environmental states and software agent states, a plurality of policies of transitioning from the environmental states and software agent states to actions, rules that determine a scalar immediate reward based on the transitioning, and rules that describe what the at least software agent detects;
identifying at least one unstable state from a series of values of the set of actions in the state-action table in which the series of values differ from each other by a settable threshold;
selecting one or more policies to split the at least one unstable state that has been identified; and
using the policies selected, splitting the unstable state to a multiple set of new states in the state-action table.

2. The computer-implemented method of claim 1, wherein the selecting the one or more policies includes selecting one or more of a regression model, a Pearson correlation coefficient, or mutual information between rows of the state-action table.

3. The computer-implemented method of claim 1, wherein the selecting the unstable state to split is based upon the one or more polices with a high correlation between a numerical value of the policies and a score adjustment trend.

4. The computer-implemented method of claim 1, wherein the selecting the unstable state to split is based upon at least one categorical value for the policies with a low correlation between the categorical value and a value for stableness.

5. The computer-implemented method of claim 1, further comprising:
identifying at least one stable state from a series of values of the set of actions in the state-action table in which the series of values differ from each other by a settable threshold; and
based on the at least one stable state selected, merging the at least one stable state to a single set of states in the state-action table.

6. The computer-implemented method of claim 1, wherein the selecting the unstable state to split based upon the one or more policies includes using two or more policies.

7. The computer-implemented method of claim 1, wherein the operating a reinforcement learning model using a state-action table with the set of environment states represent data captured with environmental sensors.

8. A computer system for automatic state adjustment, the computer system comprising:
a processor device; and
a memory operably coupled to the processor device and storing computer-executable instructions causing:
operating a reinforcement learning model using a state-action table with a set of environment states, a set of software agent states of at least one software agent, a set of actions corresponding to the set of environmental states and software agent states, a plurality of policies of transitioning from the environmental states and software agent states to actions, rules that determine a scalar immediate reward based on the transitioning, and rules that describe what the at least software agent detects;
identifying at least one unstable state from a series of values of the set of actions in the state-action table in which the series of values differ from each other by a settable threshold;
selecting one or more policies to split the at least one unstable state that has been identified; and
using the policies selected, splitting the unstable state to a multiple set of new states in the state-action table.

9. The computer system of claim 8, wherein the selecting the one or more policies includes selecting one or more of a regression model, a Pearson correlation coefficient, or mutual information between rows of the state-action table.

10. The computer system of claim 8, wherein the selecting the unstable state to split is based upon the one or more polices with a high correlation between a numerical value of the policies and a score adjustment trend.

11. The computer system of claim 8, wherein the selecting the unstable state to split is based upon at least one categorical value for the policies with a low correlation between the categorical value and a value for stableness.

12. The computer system of claim 8, further comprising:
identifying at least one stable state from a series of values of the set of actions in the state-action table in which the series of values differ from each other by a settable threshold; and
based on the at least one stable state selected, merging the at least one stable state to a single set of states in the state-action table.

13. The computer system of claim 8, wherein the selecting the unstable state to split based upon the one or more policies includes using two or more policies.

14. The computer system of claim 8, wherein the operating a reinforcement learning model using a state-action table with the set of environment states represent data captured with environmental sensors.

15. A computer program product for automatic state adjustment, the computer program product comprising:
a non-transitory computer readable storage medium readable by a processing device and storing program instructions for execution by the processing device, said program instructions comprising:
operating a reinforcement learning model using a state-action table with a set of environment states, a set of software agent states of at least one software agent, a set of actions corresponding to the set of environmental states and software agent states, a plurality of policies of transitioning from the environmental states and software agent states to actions, rules that determine a scalar immediate reward based on the transitioning, and rules that describe what the at least software agent detects;
identifying at least one unstable state from a series of values of the set of actions in the state-action table in which the series of values differ from each other by a settable threshold;
selecting one or more policies to split the at least one unstable state that has been identified; and
using the policies selected, splitting the unstable state to a multiple set of new states in the state-action table.

16. The computer program product of claim 15, wherein the selecting the one or more policies includes selecting one or more of a regression model, a Pearson correlation coefficient, or mutual information between rows of the state-action table.

17. The computer program product of claim 15, wherein the selecting the unstable state to split is based upon the one or more polices with a high correlation between a numerical value of the policies and a score adjustment trend.

18. The computer program product of claim 15, wherein the selecting the unstable state to split is based upon at least one categorical value for the policies with a low correlation between the categorical value and a value for stableness.

19. The computer program product of claim 15, further comprising:
identifying at least one stable state from a series of values of the set of actions in the state-action table in which the series of values differ from each other by a settable threshold; and
based on the at least one stable state selected, merging the at least one stable state to a single set of states in the state-action table.

20. The computer program product of claim 15, wherein the selecting the unstable state to split based upon the one or more policies includes using two or more policies.
